(19) United States
(12) Patent Application Publication
(10) Pub. No.: US 2012/0157049 A1
(43) Pub. Date: Jun. 21, 2012

(54) CREATING A RESTRICTED ZONE WITHIN AN OPERATING SYSTEM

(76) Inventors: Nichola Eliovits, San Jose, CA (US); Peter Ajlouny, San Jose, CA (US)

(21) Appl. No.: 13/329,287

(22) Filed: Dec. 18, 2011

Related U.S. Application Data
(60) Provisional application No. 61/424,469, filed on Dec. 17, 2010.

(51) Int. Cl. H04W 12/06; H04W 12/08; H04W 4/02; G06F 21/22

(52) U.S. Cl. 455/411; 726/28

(57) ABSTRACT

A system for creating a restricted zone within an operating system, in one example embodiment, includes a communication module to receive from a user with administrative authority a request to associate the restricted zone with one or more software applications or processes and to receive a request from a user to access an application, a processing module to determine whether the application or the process is within the restricted zone, and an access module to selectively allow access to the application or process based on the determination.

### CROSS-REFERENCE TO RELATED APPLICATIONS

This application claims priority of U.S. Provisional Application No. 61/424,469, entitled “CREATING A RESTRICTED ZONE WITHIN AN OPERATING SYSTEM,” filed Dec. 17, 2010, which is incorporated herein by reference in its entirety for all purposes.

### FIELD

This application relates to data processing, and more specifically, to reducing access to certain applications by creating a restricted zone with protective functionality within an operating system.

### BACKGROUND

Content-control software may help control whatever content is permitted to a user, especially when it is used to restrict material delivered over a network. The motive is often to prevent the user from viewing content which the device owner may consider sensitive or objectionable. Additionally, a network access control may be used to define and implement a policy that describes how to secure access by user devices to network nodes. However, any existing solution designed to limit access to certain content or network resources does so by implementing general restrictions. Thus, an existing solution may allow controlling the access of a third party (e.g., a child, friend, husband, and wife) to a device (e.g., a smartphone, a portable media device, or a stationary media device) by preventing access to certain content within all applications or by preventing access to all applications installed on a certain device. In order to gain access to the device, the third party has to enter appropriate credentials. Thus, the only choices are total access or no access.

### SUMMARY

This summary is provided to introduce a selection of concepts in a simplified form. These concepts are further described below within the detailed description. This summary is not intended to identify key or essential features, nor is it intended to be used as an aid in determining the scope of the claimed subject matter.

In an example, a system for creating a restricted zone within an operating system comprises a communication module to receive, from a user with administrative authority, a request to associate the restricted zone with one or more software applications or processes and to receive, from a user, a request to access an application; a processing module to determine whether the application or process is in the restricted zone; and an access module to selectively allow access to the application or process based on the determination.

In further examples, steps of a method corresponding to the above system are stored on a machine-readable medium comprising instructions, which, when implemented by one or more processors, perform the method. In examples, subsystems or devices may be adapted to perform the method. Other features, examples, and embodiments are described below.

### BRIEF DESCRIPTION OF DRAWINGS

Embodiments are illustrated by way of example and not limitation in the figures of the accompanying drawings, in which like references indicate similar elements and in which:

FIG. 1 is a block diagram showing a network environment within which the systems and methods for creating a restricted zone within an operating system are implemented, in accordance with an example embodiment;

FIG. 2 is a block diagram showing, a restricted zone engine, in accordance with an example embodiment;

FIG. 3 is a process flow diagram, showing a method for creating a restricted zone within an operating system, in accordance with an example embodiment;

FIG. 4 is a process flow diagram, showing a method for creating a restricted zone within an operating system, in accordance with an example embodiment;

FIGS. 5-22 are screenshots of a method for the creation and operation of a restricted zone within an operating system, in accordance with an example embodiment; and

FIG. 23 is a diagrammatic representation of an example machine in the form of a computer system within which a set of instructions, for causing the machine to perform any one or more of the methodologies discussed herein, is executed.

### DETAILED DESCRIPTION

In some example embodiments, systems and methods for creating a restricted zone within an operating system facilitate the creation, by the creator of the zone, of a restricted zone with protective functionality in an operating system in order to reduce access to specified applications.

The following detailed description includes references to the accompanying drawings, which form a part of the detailed description. The drawings show illustrations in accordance with example embodiments. These example embodiments, which are also referred to herein as “examples,” are described in enough detail to enable those skilled in the art to practice the present subject matter. The embodiments can be combined, other embodiments can be utilized, and structural and/or logical changes can be made without departing from the scope of what is claimed. The following detailed description is, therefore, not to be taken in a limiting sense, and the scope is defined by the appended claims and their equivalents. In this document, the terms “a” and “an” are used, as is common in patent documents, to include one or more than one. In this document, the term “or” is used to refer to a nonexclusive “or,” such that “A or B” includes “A but not B,” “B but not A,” and “A and B,” unless otherwise indicated.

In some example embodiments, the systems and methods may allow for children to use user devices with ad-disabled access to installed applications and provide other features specified by parents. This approach may eliminate any worry of lending a device to children, or any other third party, by allowing the owner of the device to select which applications installed on their telephone, tablet, or other multimedia device they would like their child or another person to have access to, and to create a password-protected zone with only the allowed applications listed and accessible.

In the case of a smartphone, parents may select whether or not the restricted zone will allow incoming calls, make the calls password-protected, or route them directly to the voicemail associated with the telephone. The systems and methods for creating a restricted zone may allow hiding or displaying Short Message Service (SMS) or notification pop-ups.

For example, the owner of the device may create a restricted zone (KidZone) designed to limit children's access to certain applications by placing these applications in KidZone. Alternatively, all applications of the device may be limited by default, and the owner may populate KidZone by approving certain applications. Children may not access any application not approved for KidZone, even from within an application that is approved. A child may not be able to circumvent KidZone by turning the device off and back on or even by rebooting the operating system. The only way to exit KidZone is to enter the password created by the device owner, which may also be e-mailed and stored on a service provider server in case it is ever forgotten and needs to be retrieved.

The systems and methods for creating a restricted zone within an operating system may allow letting children or another third party use a telephone without concern for them making calls, accessing work e-mails, or meddling with other private or sensitive applications or information stored on the device without the owner's approval. This approach may also allow parents to control whether or not their child is to be able to view advertisements when they intentionally or inadvertently click an advertisement link within an application running in KidZone. If the advertisement link leads to a webpage, not adding an appropriate web browser to the approved applications list may result in preventing the display of the advertisement when the link is clicked.

Additionally, systems and methods for creating a restricted zone within an operating system may allow parents control over whether a child may download any free or paid applications. For example, free downloads or purchases of applications may be prevented by not approving the application store application in KidZone. This approach may protect against children clicking on an advertisement from within an approved application that opens the application store application rather than a browser-based advertisement.

Additionally, systems and methods for creating a restricted zone within an operating system may allow lending a user device to strangers. If the device owner wants to let someone use their phone to make a call, but nothing else, he or she may simply select the phone dialer application from the list of available applications, enter the restricted zone, and the third party may only be able to make outgoing calls and nothing else.

The systems and methods for creating a restricted zone within an operating system may be implemented as a software application downloadable and installable on multimedia devices, such as smartphones, tablets, and computers. Once installed, the software application may allow users to select applications in order to place them in a restricted zone within an operating system. Only applications loaded into the restricted zone may be accessed by users. For smartphones, a user may specify how the restricted zone created by the software will respond to incoming calls, notifications, and/or messages that would otherwise be relevant to the user. For other multimedia devices, different settings may be selected to determine how the restricted zone will respond to certain processes specific to the type of software and hardware.

Thus, the systems and methods for creating a restricted zone within an operating system may allow selecting multiple applications loaded on a multimedia device and allow access to only those specified in a secured zone. Additionally, the systems and methods may allow controlling incoming calls and notifications by requiring password entry to answer or view while granting access to other applications and not locking a user out of the entire phone.

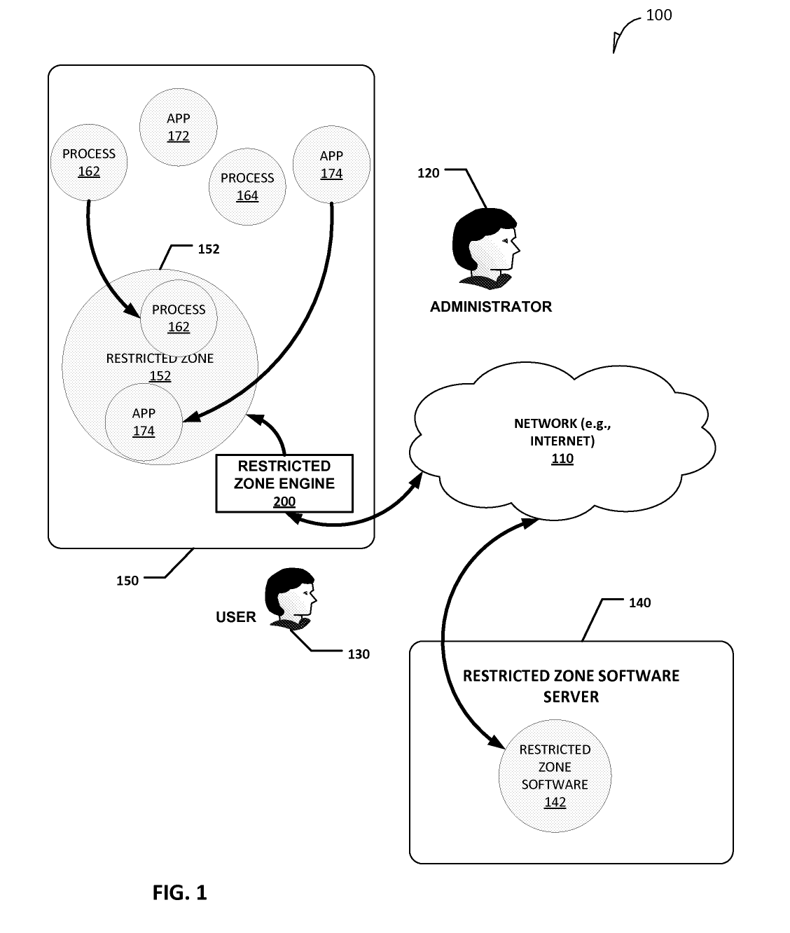

FIG. 1 is a block diagram showing a network environment 100 within which the systems and methods for creating a restricted zone within an operating system are implemented, in accordance with an example embodiment. As shown in FIG. 1, the example network environment 100 may include a network (e.g., the Internet) 110, a user with administrative authority 120, a user 130, a restricted zone software server 140, and a user device 150.

The network 110, as shown in FIG. 1, is a network of data processing nodes interconnected for the purpose of data communication, which may be utilized to communicatively couple various components of the network environment 100. The network 110 may include the Internet or any other network capable of communicating data between user devices. Suitable networks may include or interface with any one or more of, for instance, a local intranet, a PAN (Personal Area Network), a LAN (Local Area Network), a WAN (Wide Area Network), a MAN (Metropolitan Area Network), a virtual private network (VPN), a storage area network (SAN), a frame relay connection, an Advanced Intelligent Network (AIN) connection, a synchronous optical network (SONET) connection, a digital T1, T3, E1 or E3 line, Digital Data Service (DDS) connection, DSL (Digital Subscriber Line) connection, an Ethernet connection, an ISDN (Integrated Services Digital Network) line, a dial-up port such as a V.90, V.34 or V.34bis analog modem connection, a cable modem, an ATM (Asynchronous Transfer Mode) connection, or an FDDI (Fiber Distributed Data Interface) or CDDI (Copper Distributed Data Interface) connection. Furthermore, communications may also include links to any of a variety of wireless networks, including WAP (Wireless Application Protocol), GPRS (General Packet Radio Service), GSM (Global System for Mobile Communication), CDMA (Code Division Multiple Access) or TDMA (Time Division Multiple Access), cellular phone networks, GPS (Global Positioning System), CDPD (cellular digital packet data), RIM (Research in Motion, Limited) duplex paging network, Bluetooth radio, or an IEEE 802.11-based radio frequency network. The network 110 can further include or interface with any one or more of an RS-232 serial connection, an IEEE-1394 (Firewire) connection, a Fiber Channel connection, an IrDA (infrared) port, a SCSI (Small Computer Systems Interface) connection, a USB (Universal Serial Bus) connection or other wired or wireless, digital or analog interface or connection, mesh or Digi® networking.

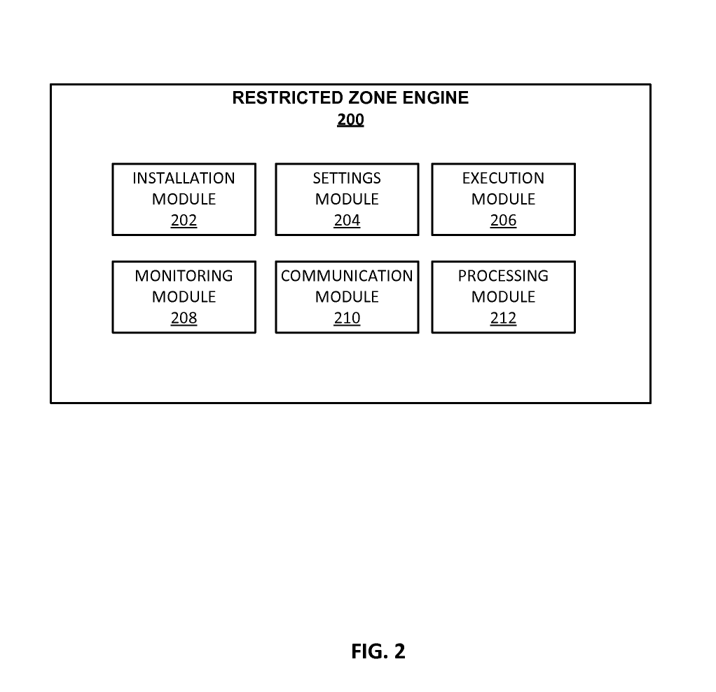

The restricted zone software server 140 may host restricted zone software 142 downloadable by the user with administrative authority 120 for installation on the device 150. The restricted zone software server 140 may refer to the hardware, the computer or the software that helps to deliver the restricted zone software 142 through the network 110 to the device 150. As shown in FIG. 1, the device 150 may include a restricted zone 152 with an application 174 and/or a process 162 to be accessible by the user 130 from within the restricted zone 152. An application 172 and/or a process 164 are shown as not included in the restricted zone 152 and, therefore, may not be accessible directly or by a link from within the restricted zone 152. The restricted zone 152 may be set up by installing the restricted zone engine 200. The restricted zone engine by be installed by running the restricted zone software 142 downloaded from the restricted zone software server 140. The restricted zone engine 200 is described in more detail below with reference to FIG. 2.

FIG. 2 is a block diagram showing the restricted zone engine 200, in accordance with an example embodiment. As shown in FIG. 2, the restricted zone engine 200 may include an installation module 202, a settings module 204, an execution module 206, a monitoring module 208, a communication module 210, and a processing module 212. The installation module 202 may be configurable to install the restrictive zone 152 on the operating system of the device 150 by allowing the user with administrative authority 120 to run the restricted zone software 142.

The settings module 204 may be configurable to identify the preferences of the user with administrative authority 120 for various settings associated with the restricted zone 152. The execution module 206 may be configurable to take over the operating system of the device 150 and to make the restricted zone 152 a locked zone allowing access to applications and processes to occur based on the restrictions/settings controlled by the settings module 204. The monitoring module 208 may monitor running of the restricted zone 152, and every time the user 130 attempts to access an application and/or process, may verify if the prompted application and/or process are allowed based on the settings of the restricted zone 152 maintained by the settings module 204. If the processing module 212 determines that the application is within the restricted zone 152, the user 130 may be allowed to access the application. If the application is within the restricted zone 152, the user 130 may be allowed to change application settings. The processing module 212 may also be configurable to close the restricted zone 152 and to restore the natural state of the operating system of the restricted zone 152. The communication module 210 may be configurable to receive a request from the user with administrative authority 120 to associate the restricted zone with one or more software applications or processes and to receive a request to access an application from the user 130. The processing module 212 may also be configurable to determine whether the application or process is in the restricted zone 152.

In some example embodiments, features may be added that lock the device 150 or its operating system into the restricted zone 152 during specific predetermined time periods. For example, the device 150 may lock the system in the restricted zone 152 (e.g., phone only mode) during school hours and automatically go back to the main operating system at the end of such time period.

In some example embodiments, the user 130 may be restricted to certain applications/functionality/processes based on physical locations determined using a Global Positioning System (GPS) native to the device 150. Additionally, activation of the restricted zone 152 may be based on location using the GPS, so that certain functionality is disabled at a particular location and enabled at another location. As mentioned, when a teen/child is at school, their phone GPS would identify them as being within X range of their school or another location, and the phone may disable outgoing calls, SMS, games, and so forth or only allow applications designated by the user with administrative authority 120, while at another location, other features may be locked/unlocked. The user with administrative authority 120 may be allowed set up multiple “zone” profiles so that a predefined list of applications and/or processes may be quickly selected for a particular user.

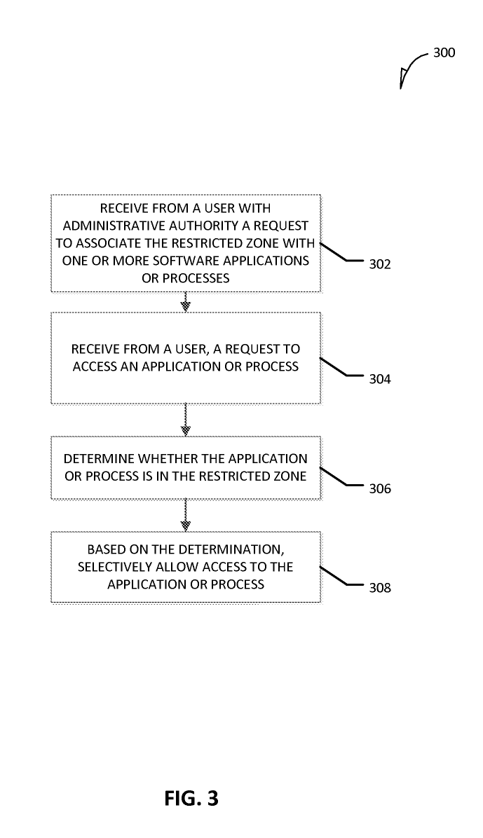

FIG. 3 is a flow chart of a method 300 for creating a restricted zone within an operating system, in accordance with an example embodiment. The method 300 may be performed by processing logic that may comprise hardware (e.g., dedicated logic, programmable logic, microcode, etc.), software (such as run on a general-purpose computer system or a dedicated machine), or a combination of both. In one example embodiment, the processing logic resides at the restricted zone engine 200 illustrated in FIG. 2. The method 300 may be performed by the various modules discussed above with reference to FIG. 2. Each of these modules may comprise processing logic.

The method 300 may commence at operation 302 with the communication module 210 receiving from the user with administrative authority 120 a request to associate the restricted zone 152 with one or more software applications or processes. Once the restricted zone 152 is set up, a request (at operation 304) to access an application or a process may be evaluated at operation 306 by the processing module 212 to determine whether or not the application or the process is within the restricted zone 152. Based on the determination made by the processing module 212, access to the application or process may be allowed or disallowed at operation 308.

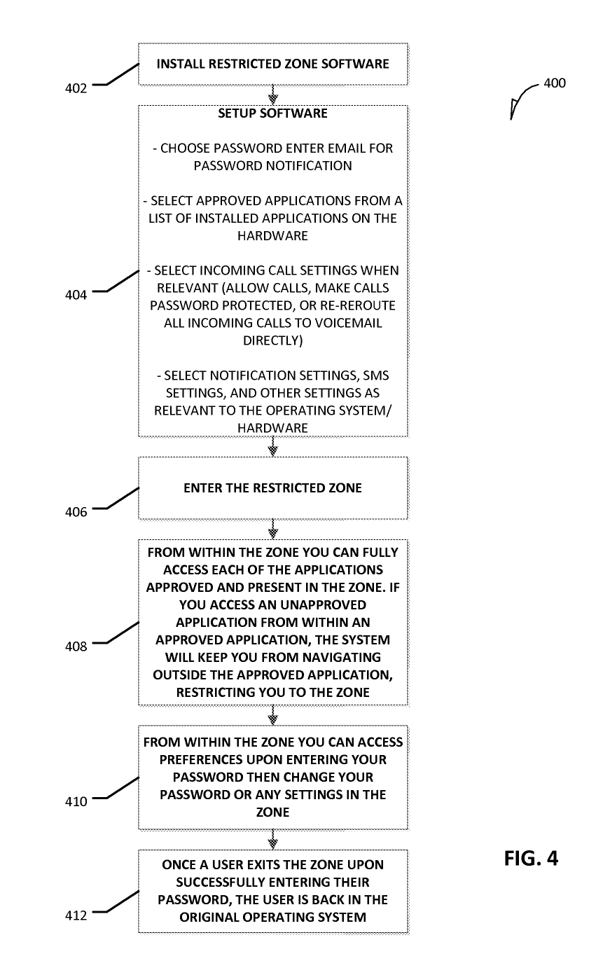

FIG. 4 is a flow chart of a method 400 for creating a restricted zone within an operating system, in accordance with an example embodiment. The method 400 may be performed by processing logic that may comprise hardware (e.g., dedicated logic, programmable logic, microcode, etc.), software (such as run on a general-purpose computer system or a dedicated machine), or a combination of both. In one example embodiment, the processing logic resides at the restricted zone engine 200 illustrated in FIG. 2. The method 400 may be performed by the various modules discussed above with reference to FIG. 2. Each of these modules may comprise processing logic.

The method 400 may commence at operation 402 with installation of the “Kidzone” software. The software can be setup at operation 404. The setup may include choosing a password and entering and email for password notification. The setup may further include selecting approved applications from a list of applications installed on the device 150, selecting incoming call settings when relevant (allow calls, make calls password protected, or re-reroute all incoming calls directly to voicemail), and select notification settings, SMS settings, and other settings as relevant to the operating system/hardware.

At operation 406, the user 130 may enter the restricted zone 152 and, at operation 408, from within the restricted zone 152, the user 130 may fully access each of the applications approved and present in the restricted zone 152. If the user 130 accesses an unapproved application from within an approved application, the restricted zone engine 200 may keep the user 130 from navigating outside the approved application, thereby restricting the user 130 to the restricted zone 152. At operation 410, from within the restricted zone 152, the user 130 may access preferences upon entering his or her password to change their password or any settings in the restricted zone 152. Once the user 130 exits the restricted zone 152 upon successfully entering his or her password at operation 412, the user 130 is back in the original operating system of the device 150.

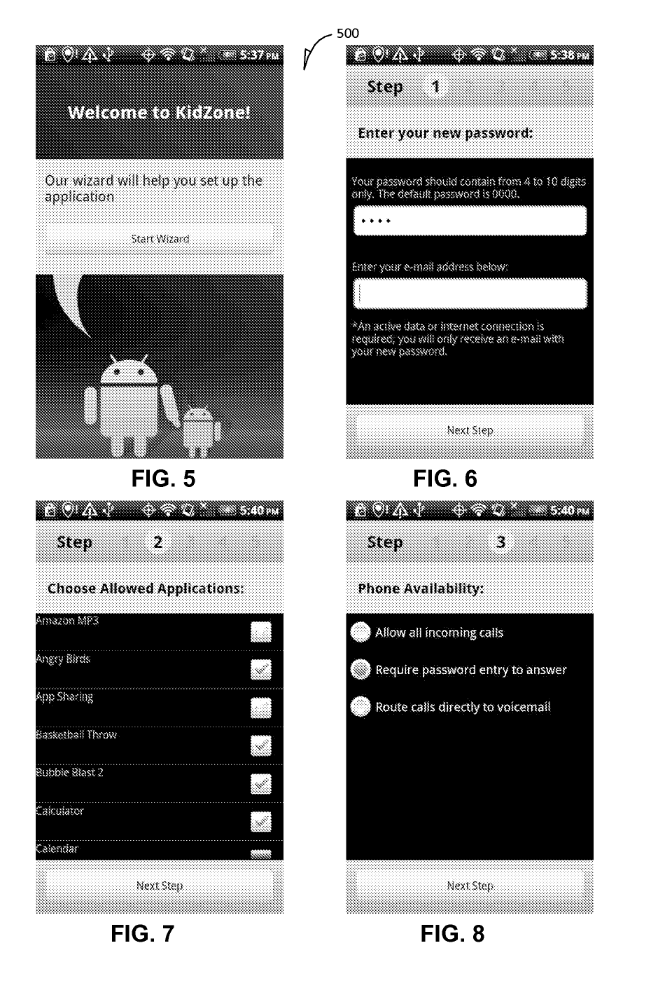

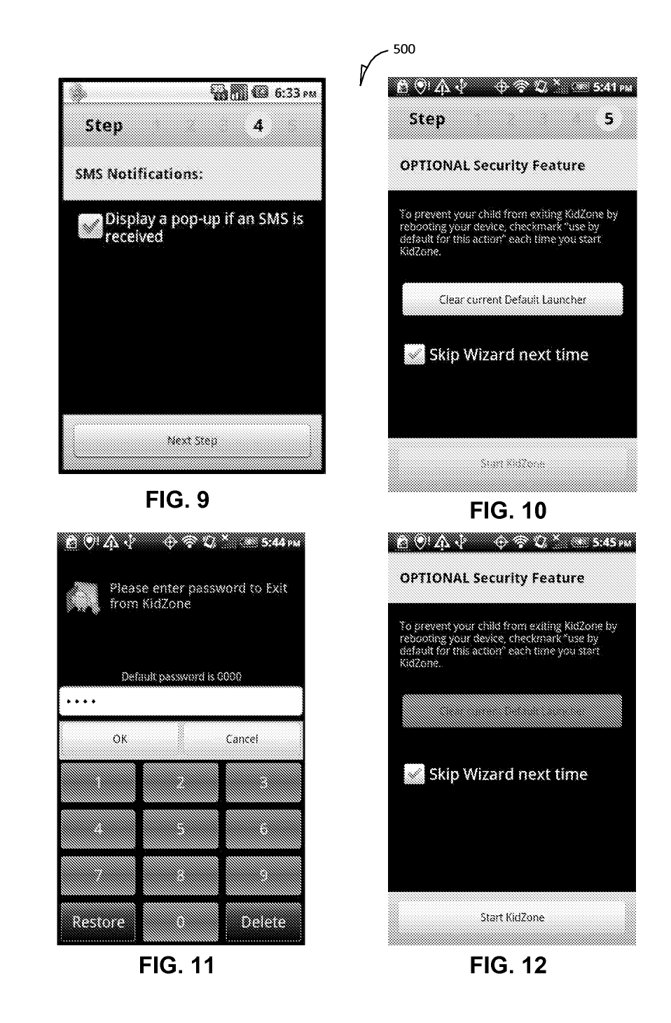

FIGS. 5-22 are screenshots of a method 500 for the creation and operation of a restricted zone within an operating system, in accordance with an example embodiment. As shown in FIGS. 5-22, the method 500 may commence with a wizard start page as shown in FIG. 5. The wizard may help the user with administrative authority 120 to set up the restricted zone 152. As shown in FIG. 6, the user with administrative authority 120 may enter a password and an email to receive a confirmation. As shown in FIG. 7, the user with administrative authority 120 may continue by selecting applications allowed within the restricted zone 152. As shown in FIG. 8, the user with administrative authority 120 may specify phone availability by selecting whether to allow incoming calls, require password entry to answer, and/or route calls directly to voicemail. As shown in FIG. 9, the user with administrative authority 120 may specify SMS notification options by selecting whether to display a pop-up if an SMS is received. As shown in FIG. 10, the user with administrative authority 120 may specify optional security features by skipping the wizard next time the device 150 starts. This approach may allow preventing the user 130 from exiting the restricted zone by rebooting the device 150. Accordingly, the user with administrative authority 120 may use the selected options without having to go through the set up each time the device 150 starts. As shown in FIG. 11, the user with administrative authority 120 may enter a password to exit the setup and select to skip the wizard next time the device 150 starts as shown in FIG. 12.

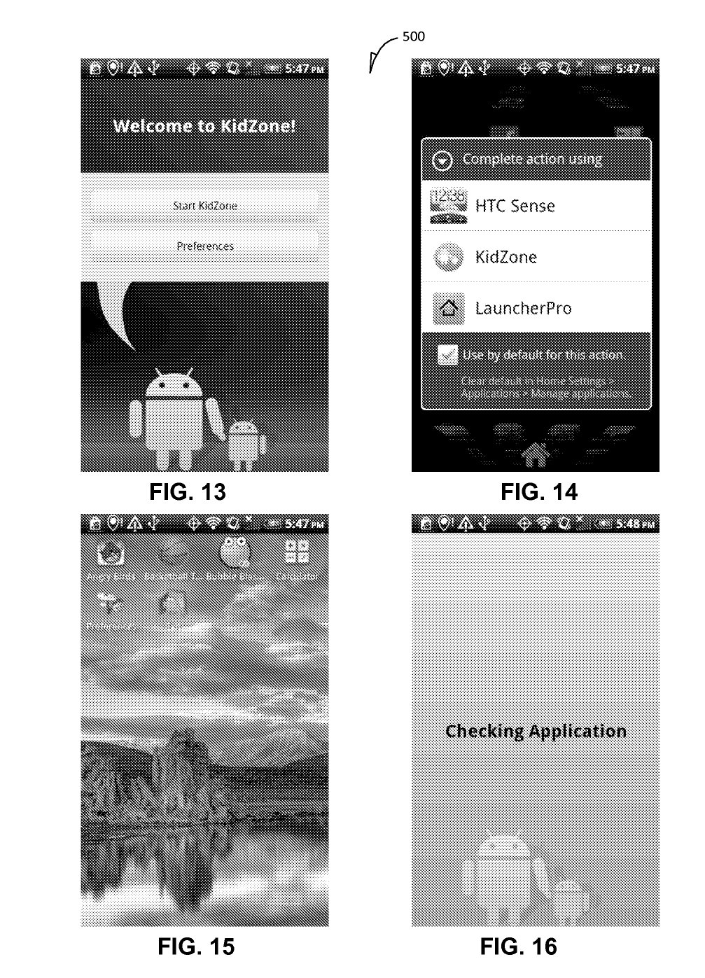

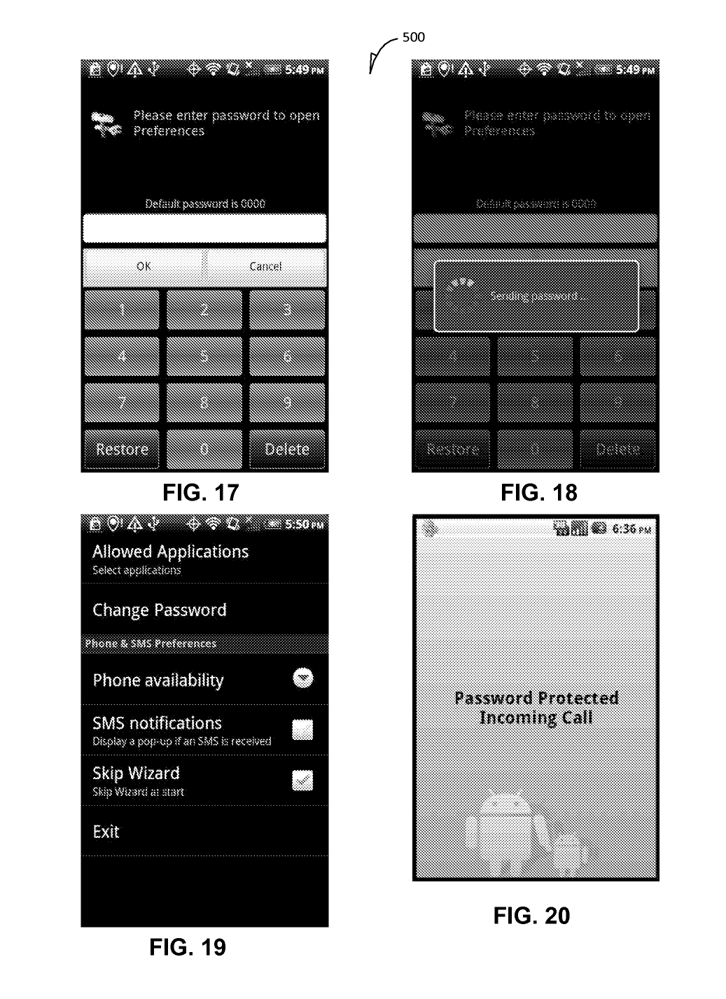

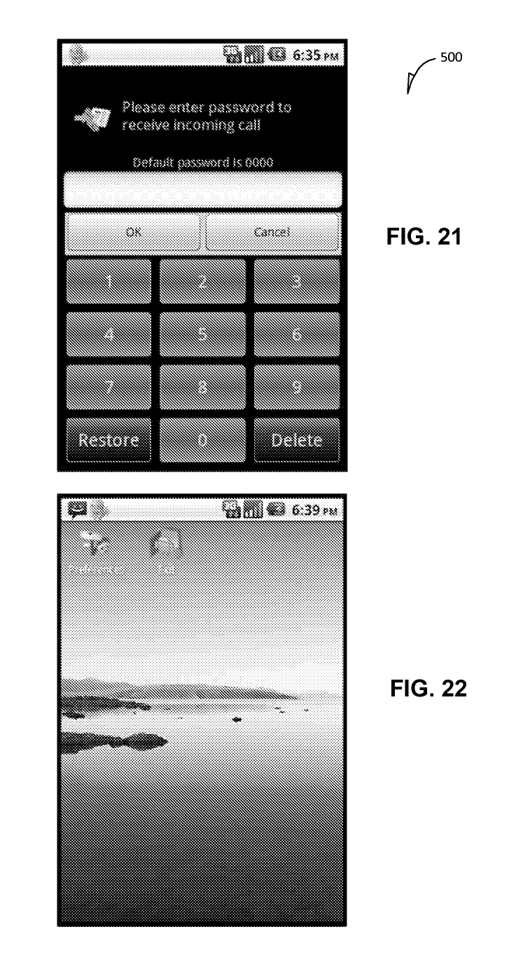

The welcome page is shown in FIG. 13. The user 130 may select to enter the restricted zone 152 or to select preferences. As shown in FIG. 14, the user 130 may select to complete an action using various options, including the restricted zone 152. FIG. 15 shows the home screen of the device 150 with the user 130 operating within the restricted zone 152. When the user 130 attempts to access an application, the application is checked as shown in FIG. 16. As shown in FIG. 17, the user 130 may enter a password to open preferences. The password is sent as shown in FIG. 18 and, if successful, the user 130 enters the preferences as shown in FIG. 19. When a call is made to the device 150 while the user 130 is within the restricted zone 152, the call may be password-protected as shown in FIG. 20. To take the call, the user 130 may have to enter the appropriate password as shown in FIG. 21.

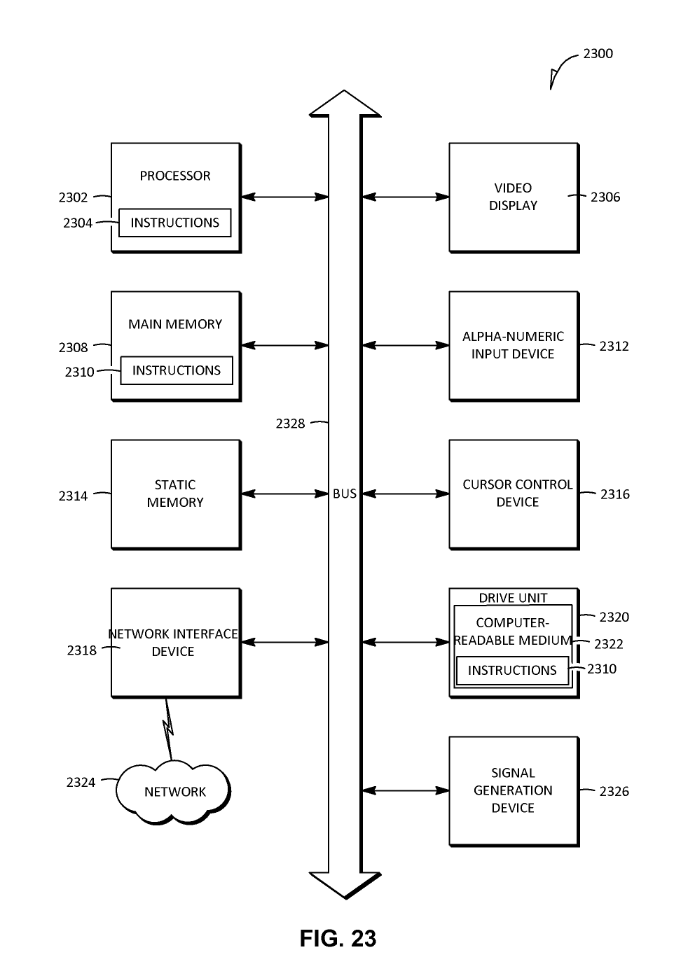

FIG. 23 shows a diagrammatic representation of a machine in the example form of a computer system 2300, within which a set of instructions for causing the machine to perform any one or more of the methodologies discussed herein may be executed. In various example embodiments, the machine operates as a stand-alone device or may be connected (e.g., networked) to other machines. In a networked deployment, the machine may operate in the capacity of a server or a client machine in a server-client network environment, or as a peer machine in a peer-to-peer (or distributed) network environment. The machine may be a personal computer (PC), a tablet PC, a set-top box (STB), a personal digital assistant (PDA), a cellular telephone, a portable music player (e.g., a portable hard drive audio device such as an MP3 player), a web appliance, a network router, switch or bridge, or any machine capable of executing a set of instructions (sequential or otherwise) that specify actions to be taken by that machine. Further, while only a single machine is illustrated, the term “machine” may also be taken to include any collection of machines that individually or jointly execute a set (or multiple sets) of instructions to perform any one or more of the methodologies discussed herein.

The example computer system 2300 includes one or more processors 2302 (e.g., a central processing unit (CPU), a graphics processing unit (GPU) or both), a main memory 2308, and a static memory 2314, which communicate with each other via a bus 2328. The computer system 2300 may further include a video display unit 2306. The video display unit 2306 may include a liquid crystal display (LCD) or any bistable display technology. The computer system 2300 also includes an alphanumeric input device 2312 (e.g., a keyboard), a cursor control device 2316 (e.g., a mouse), a drive unit 2320, a signal generation device 2326 (e.g., a speaker), and a network interface device 2318.

The drive unit 2320 includes a machine-readable medium 2322 on which is stored one or more sets of instructions and data structures (e.g., instructions 2324), embodying or utilized by any one or more of the methodologies or functions described herein. The instructions 2310 may also reside, completely or at least partially, within the main memory 2304 and/or within the processors 2304 during execution thereof by the computer system 2300. The main memory 2308 and the processors 2302 also constitute machine-readable media.

The instructions 2310 may further be transmitted or received over a network 2324 via the network interface device 2318 utilizing any one of a number of well-known transfer protocols (e.g., Hyper Text Transfer Protocol (HTTP)).

While the machine-readable medium 2322 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding, or carrying a set of instructions for execution by the machine and that causes the machine to perform any one or more of the methodologies of the present application, or that is capable of storing, encoding, or carrying data structures utilized by or associated with such a set of instructions. The term “machine-readable medium” shall accordingly be taken to include, but not be limited to, solid-state memories, optical and magnetic media. Such media may also include, without limitation, hard disks, floppy disks, flash memory cards, digital video disks, random access memory (RAM), read only memory (ROM), and the like.

The example embodiments described herein may be implemented in an operating environment comprising software installed on a machine, in hardware, or in a combination of software and hardware.

Thus, creating a restricted zone within an operating system has been described. Although embodiments have been described with reference to specific example embodiments, it will be evident that various modifications and changes may be made to these example embodiments without departing from the broader spirit and scope of the present application. Accordingly, the specification and drawings are to be regarded in an illustrative rather than a restrictive sense.

1. A system for creating a restricted zone within an operating system, the system comprising:
a communication module to receive from a user with administrative authority a request to associate the restricted zone with one or more software applications or processes and to receive a request from a user to access the application;
a processing module to determine whether the application or the process is within the restricted zone; and
a monitoring module to monitor and to selectively allow access to the application or the process based on the determination.

2. The system of claim 1, wherein the processing module is further configured to discontinue the access to the restricted zone, restore an original state of the operating system of the restricted zone, and to determine whether the application or the process is within the restricted zone.

3. The system of claim 1, wherein the communication module is further configured to transmit the data associated with a user device to the monitoring module.

4. The system of claim 1, wherein the processing module is further configured to automatically switch between multiple restricted zones based on a predefined schedule.

5. The system of claim 1, wherein the monitoring module is further configured to:
receive GPS data from the communication module; and
make a decision on whether to grant or disallow access to the application based on a physical location of the user device.

6. The system of claim 1, wherein the processing module is further configured to automatically create the restricted zone for the user device for one or more predefined periods of time based on an adjustable time schedule.

7. The system of claim 1, wherein the monitoring module is further configured to grant or disallow access to the one or more software applications included in the restricted zone for predefined periods of time based on an adjustable time schedule.

8. A computer-implemented method for creating a restricted zone within an operating system, the method comprising:
receiving from a user with administrative authority a request to associate the restricted zone with one or more software applications or processes;
receiving a request from the user to access an application or a process;
determining whether the application or the process is within the restricted zone; and
based on the determination, selectively allowing access to the application or the process.

9. The method of claim 8, wherein creating the restricted zone within an operational system comprises protecting with a password access to the one or more software applications or processes included in the restricted zone.

10. The method of claim 8, wherein settings of the restricted zone are adjusted by the user with administrative authority to perform one or more of the following actions: receive an incoming call, make the incoming call password-protected, or route the incoming call directly to a voicemail associated with the user device.

11. The method of claim 8, wherein the one or more software applications included in the restricted zone are set by the user with administrative authority to display or hide Short Message Service (SMS) messages.

12. The method of claim 8, wherein the one or more software applications or processes included in the restricted zone are inaccessible by default and wherein access to the one or more software applications or processes is allowed by the user with administrative authority by modifying corresponding settings of the restricted zone.

13. The method of claim 8, wherein exiting the restricted zone comprises entering a password, created by the user with administrative authority.

14. The method of claim 8, wherein access to advertisements available for view by clicking a link within an application included in the restricted zone is allowed or disallowed by the user with administrative authority.

15. The method of claim 8, wherein downloading of free or paid applications using a device or operational system locked into the restricted zone is precluded by the user with administrative authority by disallowing access to a corresponding application store in settings of the restricted zone.

16. The method of claim 8, wherein ensuring secure use of the user device by a person is achieved by selecting a phone dialer application and entering the restricted zone.

17. The method of claim 8, wherein the user device or an operating system associated with the user device is locked into the restricted zone during predetermined time periods, automatically reverting to a standard mode of operation at the end of the predetermined time periods.

18. The method of claim 8, wherein the restricted zone is automatically activated for one or more software processes and applications based on the physical location of a corresponding user device using a Global Positioning System (GPS), thereby granting access to an application at a first location and disallowing it at a second location.

19. The method of claim 8, wherein multiple restricted zones are switched between automatically based on a predetermined time schedule.

20. A machine-readable medium comprising instructions, which when implemented by one or more processors, perform the following operations:
receive from the user with administrative authority a request to associate the restricted zone with one or more software applications or processes;
receive a request from the user to access an application or process;
determine whether the application or process is within the restricted zone; and
based on the determination, selectively allow access to the application or process.
